(19) United States
(12) Patent Application Publication
(10) Pub. No.: US 2026/0128502 A1
(43) Pub. Date: May 7, 2026

(54) ELECTRONIC DEVICE

(71) Applicant: REALME MOBILE TELECOMMUNICATIONS (SHENZHEN) CO., LTD., Shenzhen (CN)

(72) Inventors: Tao ZHANG, Shenzhen (CN); En WU, Shenzhen (CN)

(73) Assignee: REALME MOBILE TELECOMMUNICATIONS (SHENZHEN) CO., LTD., Shenzhen (CN)

(21) Appl. No.: 19/436,978

(22) Filed: Dec. 30, 2025

Related U.S. Application Data
(63) Continuation of application No. PCT/CN2024/130209, filed on Nov. 6, 2024.

(30) Foreign Application Priority Data
Nov. 14, 2023 (CN) 202311519616.5

(51) Int. Cl. H01Q 1/24; H01Q 1/52; H01Q 21/28

(52) U.S. Cl. CPC H01Q 1/243; H01Q 1/521; H01Q 21/28

(57) ABSTRACT

An electronic device is provided and includes a first antenna and a second antenna; the first antenna is a near field communication antenna disposed above a pressure plate bracket of the electronic device, and is disposed adjacent to the second antenna; a radiator of the first antenna is connected to an anti-interference circuit, and a connection point between the radiator and the anti-interference circuit is located at a location on the radiator of the first antenna other than a feed point of the first antenna and a ground point of the first antenna; the anti-interference circuit is configured to reduce interference between the first antenna and the second antenna.

### CROSS REFERENCE TO RELATED APPLICATIONS

The present disclosure is a continuation of International Patent Application No. PCT/CN2024/130209, filed on Nov. 6, 2024, which claims priority to Chinese Patent Application No. 202311519616.5 and filed on Nov. 14, 2023, both of which are herein incorporated by reference in their entireties.

### TECHNICAL FIELD

The present disclosure relates to anti-interference technologies between antennas, and in particular to an electronic device.

### BACKGROUND

Currently, a Computer Numerical Control (CNC) metal frame scheme and a Mode Decoration Antenna (MDA) process scheme is used in an antenna design of a mobile phone. However, due to a space limitation in the mobile phone frame, not all antennas may be designed on the frame. Therefore, a Flexible Printed Circuit board (FPC) may be separately added on a pressure plate bracket of the mobile phone to serve as a cellular antenna, a Bluetooth (BT) antenna, or an antenna with other frequency band.

For example, a Near Field Communication (NFC) antenna is separately disposed above the pressure plate bracket. In this case, a mutual interference generates between the cellular antenna FPC and the NFC antenna, a spacing between the cellular antenna FPC and the NFC antenna is required to be increased. However, due to the limitation in the internal space of the mobile phone, the NFC antenna is forced close to the inner side of the mobile phone, reducing user experience. Thus, it may be seen that in the related art, electronic devices suffer from the technical problem of the mutual interference between two antennas due to the limitation in the internal space of the electronic devices.

### SUMMARY

Some embodiments of the present disclosure provide an electronic device, including a first antenna and a second antenna; the first antenna is a near field communication antenna disposed above a pressure plate bracket of the electronic device, and is disposed adjacent to the second antenna; an anti-interference circuit is connected to a radiator of the first antenna, and a connection point between the radiator and the anti-interference circuit is located at a location other than a feed point of the first antenna and a ground point of the first antenna on the radiator of the first antenna; the anti-interference circuit is configured to reduce interference between the first antenna and the second antenna.

Some embodiments of the present disclosure provide another electronic device, including a first antenna and a second antenna disposed adjacent to the first antenna, the first antenna being a near field communication antenna, wherein a location other than a feed point of the first antenna and a ground point of the first antenna on a radiator of the first antenna is grounded to reduce interference between the first antenna and the second antenna.

Some embodiments of the present disclosure provide yet another electronic device, including a first antenna and a second antenna disposed adjacent to the first antenna, the first antenna being a near field communication antenna, wherein a plurality of exposed copper points are disposed on a radiator of the first antenna to reduce interference between the first antenna and the second antenna.

### BRIEF DESCRIPTION OF THE DRAWINGS

FIG. 1 is a structural schematic diagram of an electronic device according to some embodiments of the present disclosure.

FIG. 2 is a structural schematic view of antennas in an electronic device in the related art.

FIG. 3 is a structural schematic view of an example of antennas of an electronic device according to some embodiments of the present disclosure.

FIG. 4 is a structural schematic diagram of a first example of an antenna routing of an electronic device according to some embodiments of the present disclosure.

FIG. 5 is a structural schematic diagram of an example of an anti-interference circuit according to some embodiments of the present disclosure.

FIG. 6 is a structural schematic view of a second example of an antenna routing of an electronic device according to some embodiments of the present disclosure.

FIG. 7 is a schematic diagram of simulation results of antennas according to some embodiments of the present disclosure.

FIG. 8 is a structural schematic diagram of a third example of antenna routings of an electronic device according to some embodiments of the present disclosure.

### DETAILED DESCRIPTION

Some embodiments of the present disclosure provide an electronic device, including a first antenna and a second antenna; the first antenna is a near field communication antenna disposed above a pressure plate bracket of the electronic device, and is disposed adjacent to the second antenna; an anti-interference circuit is connected to a radiator of the first antenna, and a connection point between the radiator and the anti-interference circuit is located at a location other than a feed point of the first antenna and a ground point of the first antenna on the radiator of the first antenna; the anti-interference circuit is configured to reduce interference between the first antenna and the second antenna.

In some embodiments, the anti-interference circuit includes a grounding circuit; the grounding circuit is connected to the radiator of the first antenna.

In some embodiments, the grounding circuit is grounded through an antenna spring piece, a foam, an exposed copper, or a screw hole.

In some embodiments, the anti-interference circuit further includes a matching circuit; the matching circuit includes a capacitor and an inductor; one end of the capacitor is connected to the radiator of the first antenna, another end of the capacitor is connected to one end of the inductor, and another end of the inductor is connected to the grounding circuit.

In some embodiments, the capacitor is configured to disconnect the radiator of the first antenna to the grounding circuit when the first antenna operates at an operating frequency band of the first antenna.

In some embodiments, the inductor is configured to change a flow direction of a current coupled to the first antenna from the second antenna and reduce an interference from the second antenna.

In some embodiments, the connection point between the first antenna and the anti-interference circuit is located at a location where a voltage is zero on the radiator of the first antenna, other than the feed point of the first antenna and the ground point of the first antenna.

In some embodiments, a distance between the connection point between the first antenna and the anti-interference circuit and a location at which maximum current exists on the second antenna is inversely correlated with an anti-interference capability of the anti-interference circuit.

In some embodiments, the connection point between the first antenna and the anti-interference circuit is located on the radiator of the first antenna and is closest to the location at which the maximum current exists on the second antenna.

In some embodiments, the second antenna is any one of a cellular antenna, a Wireless Fidelity antenna, a Bluetooth antenna, and a Global Positioning System antenna.

In some embodiments, the second antenna is located on the pressure plate bracket of the electronic device or is a part of a frame of the electronic device.

In some embodiments, the radiator is routed in a shape of U, in a shape of rectangular with an opening, or in an irregular shape.

Some embodiments of the present disclosure provide another electronic device, including a first antenna and a second antenna disposed adjacent to the first antenna, the first antenna being a near field communication antenna, wherein a location other than a feed point of the first antenna and a ground point of the first antenna on a radiator of the first antenna is grounded to reduce interference between the first antenna and the second antenna.

In some embodiments, the location other than the feed point and the ground point of the first antenna on the radiator of the first antenna is grounded through an antenna spring piece.

In some embodiments, the electronic device further includes a matching circuit, one end being connected to the location other than the feed point and the ground point of the first antenna on the radiator of the first antenna through an antenna spring piece, another end being grounded, such that the location other than the feed point and the ground point of the first antenna on the radiator is grounded.

In some embodiments, the matching circuit includes a capacitor and an inductor, wherein one end of the capacitor is connected to the location other than the feed point and the ground point of the first antenna on the radiator of the first antenna through the antenna spring piece, another end of the capacitor is connected to one end of the inductor, and another end of the inductor is grounded.

In some embodiments, the another end of the inductor is grounded through another antenna spring piece.

Some embodiments of the present disclosure provide yet another electronic device, including a first antenna and a second antenna disposed adjacent to the first antenna, the first antenna being a near field communication antenna, wherein a plurality of exposed copper points are disposed on a radiator of the first antenna to reduce interference between the first antenna and the second antenna.

In some embodiments, the plurality of exposed copper points are disposed close to a physical center point of the radiator of the first antenna, and the physical center point of the radiator of the first antenna has a voltage of zero.

In some embodiments, each of the plurality of exposed copper points is grounded through a foam.

The technical solutions in the embodiments of the present disclosure will be clearly and completely described below with reference to the accompanying drawings in some embodiments of the present disclosure.

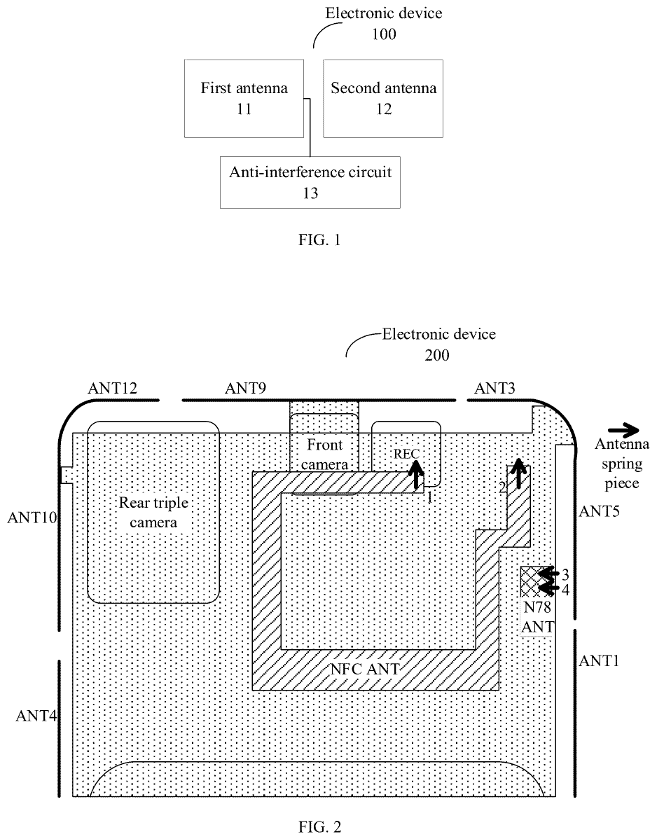

Some embodiments of the present disclosure provide an electronic device. FIG. 1 is a structural schematic diagram of an electronic device according to some embodiments of the present disclosure. As shown in FIG. 1, the electronic device 100 may include a first antenna 11 and a second antenna 12. The first antenna 11 may be a near field communication antenna disposed above a pressure plate bracket of the electronic device 100. The first antenna 11 may be disposed adjacent to the second antenna 12.

A radiator of the first antenna 11 is connected to an anti-interference circuit 13, and a connection point between a radiator of the first antenna 11 and the anti-interference circuit 13 is located on the radiator of the first antenna 11 other than a feed point of the first antenna 11 and a ground point of the first antenna 11.

The anti-interference circuit 13 is configured to reduce interference between the first antenna 11 and the second antenna 12.

In practical applications, the first antenna 11, as a near field communication antenna, is located on the pressure plate bracket of the electronic device 100. There exists interference between the first antenna 11 and the adjacent second antenna 12, resulting in low antenna efficiencies of the first antenna 11 and the second antenna 12. To reduce the interference between the first antenna 11 and the second antenna 12 and improve the antenna efficiencies of the first antenna 11 and the second antenna 12, an anti-interference circuit 13 is connected to a location on the radiator of the first antenna 11 other than the feed point and the ground point of the first antenna 11. The anti-interference circuit 13 may reduce the interference between the first antenna 11 and the second antenna 12.

The radiator of the first antenna 11 may be routed in a shape of U, in a shape of rectangular with an opening, or in an irregular shape, which is not limited.

In a case of the second antenna 12 being disposed adjacent to the first antenna 11, when the shortest distance between a location at which the maximum current exists on the second antenna 12 is located and the radiator of the first antenna 11 is 3-5 mm, a mutual interference may be generated between the first antenna 11 and the second antenna 12, leading to low antenna efficiencies of the first antenna 11 and the second antenna 12. In this case, by connecting the anti-interference circuit 13 to a location on the radiator of the first antenna 11 other than the feed point and the ground point of the first antenna 11, the interference between the first antenna 11 and the second antenna 12 may be reduced, thereby improving the antenna efficiencies of the first antenna 11 and the second antenna 12.

The second antenna 12 may be any one of a cellular antenna, a Wireless Fidelity antenna, a Bluetooth antenna, and a Global Positioning System antenna. That is, when the first antenna 11, i.e., the near field communication antenna, is connected to the anti-interference circuit 13, the interference between the first antenna 11 and an adjacent cellular antenna may be reduced, or interference between the first antenna 11 and an adjacent Wireless Fidelity antenna may be reduced, or interference between the first antenna 11 and an adjacent Bluetooth antenna may be reduced, or interference between the first antenna 11 and an adjacent Global Positioning System antenna may be reduced, thereby improving the antenna efficiencies of the two antennas.

It should be noted that the second antenna 12 is located on the pressure plate bracket of the electronic device 100 or a frame of the electronic device 100. That is, the second antenna 12 may be an antenna disposed on the pressure plate bracket, or an antenna using the frame of the electronic device 100 as a body of the second antenna 12. When each antenna located on these two locations is adjacent to the first antenna 11 to cause mutual interference, the anti-interference circuit 13 may be adopted to be connected to the location on the radiator of the first antenna 11 other than the feed point and the ground point of the first antenna 11 in some embodiments of the present disclosure. In this way, the interference between the first antenna 11 and the second antenna 12 may be reduced, thereby improving the antenna efficiencies of the first antenna 11 and the second antenna 12.

To achieve the reduction of mutual interference between the first antenna 11 and the second antenna 12 via the anti-interference circuit 13, in some embodiments, the anti-interference circuit 13 may include a grounding circuit, and the grounding circuit is connected to the radiator of the first antenna 11.

It may be understood that the anti-interference circuit 13 may be the grounding circuit. That is, the location on the radiator of the first antenna 11 other than the feed point and the ground point of the first antenna 11 may be grounded and then may change the flow direction of the current coupled to the first antenna 11 from the second antenna 12. By adjusting the location of the connection point, the impact of grounding the connection point on the performance of the first antenna 11 may be reduced, thereby reducing the interference between the first antenna 11 and the second antenna 12.

In some embodiments, the grounding circuit may be an antenna spring piece, a foam, an exposed copper, or a screw hole, which is not limited, to be grounded.

To make the anti-interference circuit 13 reduce the impact on the performance of the first antenna 11, in some embodiments, the anti-interference circuit 13 may include a matching circuit.

The matching circuit may include a capacitor and an inductor. One end of the capacitor is connected to the radiator of the first antenna 11, another end of the capacitor is connected to one end of the inductor, and another end of the inductor is connected to the grounding circuit.

It may be understood that, a LC circuit is used as the matching circuit, one end of the capacitor is connected to the location on the radiator of the first antenna 11 other than the feed point and the ground point of the first antenna 11, another end of the capacitor is connected to one end of the inductor, and another end of the inductor is connected to the grounding circuit. In this way, the mutual interference between the first antenna 11 and the second antenna 12 is reduced via the matching circuit.

In some embodiments, an antenna spring piece may be configured to connect one end of the capacitor to the location on the radiator of the first antenna 11 other than the feed point and the ground point of the first antenna 11.

In the case where the grounded matching circuit is used as the anti-interference circuit 13 as described above, in some embodiments, the capacitor is configured to disconnect the radiator of the first antenna 11 to the anti-interference circuit 13 when the first antenna 11 operates at an operating frequency band of the first antenna 11.

It may be understood that, since the first antenna 11 is a near field communication antenna, the operating frequency of the first antenna 11 is 13.56 MHz. Since the capacitor has a characteristic of blocking low frequencies and passing high frequencies, a capacitance value of the capacitor that is capable of achieving disconnection may be selected when the first antenna 11 operates at the operating frequency band. For example, in a case where the second antenna 12 is an N78 antenna and the first antenna 11 is a near field communication antenna with an operating frequency of 13.56 MHz, the capacitance value may be selected as 100 PF. In this way, the capacitor may disconnect the first antenna 11 to the anti-interference circuit 13, thereby reducing the impact of the grounded anti-interference circuit 13 on the first antenna 11.

In the case where the grounded matching circuit is used as the anti-interference circuit 13 as described above, in some embodiments, the inductor is configured to change the flow direction of the current coupled to the first antenna 11 from the second antenna 12, so as to reduce the interference on the second antenna 12.

It may be understood that the inductor is configured to change the electrical length of the grounding current, so as to change the flow direction of the current coupled to the first antenna 11 from the second antenna 12. In some embodiments, an inductance value of the inductor may be determined based on simulation results, such that the inductance value is selected to maximize the reduction of interference on the second antenna 12.

For the selection of the connection point between the first antenna 11 and the grounding circuit, in some embodiments, the connection point between the first antenna 11 and the anti-interference circuit 13 is located at a location on the radiator of the first antenna 11, other than the ground point of the first antenna 11, where a voltage is zero.

It may be understood that, to reduce the impact of grounding on the first antenna 11, the connection point between the first antenna 11 and the anti-interference circuit 13, i.e., the connection point between the first antenna 11 and the grounding circuit, may be selected at a location on the radiator of the first antenna 11, other than the ground point, where a voltage is zero. Since the voltage at this location is zero, this location is grounded to have a little impact on the first antenna 11. Thus, the interference between the first antenna 11 and the second antenna 12 is reduced and meanwhile there is no effect on the normal operation of the first antenna 11 as soon as possible.

In the case where the grounded matching circuit is used as the anti-interference circuit 13 as described above, in some embodiments, a distance between the connection point between the first antenna 11 and the anti-interference circuit 13 and a location at which maximum current exists on the second antenna 12 is inversely correlated with the anti-interference capability of the anti-interference circuit 13.

It may be understood that the closer the connection point between the first antenna 11 and the anti-interference circuit 13 is to the location at which the maximum current exists on the second antenna 12, the stronger capability and the better effect the anti-interference circuit 13 has in reducing interference between the first antenna 11 and the second antenna 12. That is, the distance between the connection point between the first antenna 11 and the anti-interference circuit 13 and the location at which maximum current exists on the second antenna 12 is inversely correlated with the anti-interference capability of the anti-interference circuit 13. In other words, the shorter the distance between the connection point between the first antenna 11 and the anti-interference circuit 13 and the location at which maximum current exists on the second antenna 12 is, the stronger anti-interference capability the anti-interference circuit 13 has. The longer the distance between the connection point between the first antenna 11 and the anti-interference circuit 13 and the location at which maximum current exists on the second antenna 12 is, the weaker anti-interference capability the anti-interference circuit 13 has.

Thus, the connection point between the first antenna 11 and the anti-interference circuit 13 may be disposed based on the above relationship, thereby maximizing the reduction of interference between the first antenna 11 and the second antenna 12.

To maximize the reduction of interference between the first antenna 11 and the second antenna 12, in some embodiments, the connection point between the first antenna 11 and the anti-interference circuit 13 is located on the radiator of the first antenna 11 and is closest to the location at which maximum current exists on the second antenna 12.

It may be understood that, since the distance between the connection point between the first antenna 11 and the anti-interference circuit 13 and the location at which maximum current exists on the second antenna 12 is inversely correlated with the anti-interference capability of the anti-interference circuit 13, the connection point between the first antenna 11 and the anti-interference circuit 13 may be disposed at a location on the radiator of the first antenna 11 other than the feed point and the ground point, that is closest to the location at which maximum current exists on the second antenna 12. Thus, by connecting this location to the anti-interference circuit 13, the anti-interference circuit 13 may maximize the reduction of interference between the first antenna 11 and the second antenna 12.

Some examples are provided below to illustrate the electronic device described in one or more of the above embodiments.

An example in which the first antenna is an NFC antenna and the second antenna is a cellular antenna is taken for illustration. When the NFC antenna and the cellular antenna are disposed adjacent to each other and interfere with each other, to reduce this interference, a spatial distance between the cellular antenna and the NFC antenna is required to be increased. This reduces a routing area of the antennas and the performance of the cellular antenna. Additionally, the NFC antenna is required to be moved closer to an inner side of a mobile phone, which reduces the user experience of NFC. Moreover, in a scheme that an antenna layout is modified to reduce interference, once the FPC antenna is determined, adjustability in later stages is low, and a mold is required to be changed as the antenna layout is modified, which have significant impact.

This example provides a solution that may enhance performance among antennas, solving the impact between the NFC antenna and the cellular antenna via antenna design and circuit design.

The cellular antenna being an N78 antenna is taken as an example, FIG. 2 is a structural schematic view of antennas in an electronic device in the related art. FIG. 2 illustrates a conventional layout, the electronic device 200 may include an NFC Antenna (ANT), an N78 Antenna (ANT), an antenna ANT1, an antenna ANT3, an antenna ANT4, an antenna ANT5, an antenna ANT9, an antenna ANT10, and an antenna ANT12, a rear triple camera, a front camera, a Recording (REC), an antenna spring piece 1, an antenna spring piece 2, an antenna spring piece 3, and an antenna spring piece 4. The NFC ANT and the N78 ANT are both disposed on a pressure plate bracket of the electronic device 200. The antenna spring piece 1 is configured to be connected to the feed point and the antenna spring piece 2 is configured to be connected to the ground point on the NFC ANT, the antenna spring piece 3 is configured to be connected to the feed point and the antenna spring piece 4 is configured to be connected to the ground point on the N78 ANT.

In FIG. 2, the NFC ANT is located above the pressure plate bracket at the inner side of the back cover of the mobile phone, and the N78 ANT is located at the right side of the back cover of the mobile phone. The radiator of the NFC ANT is long, and a ferrite is required to be disposed below the NFC ANT. This significantly affects the performance of the N78 ANT, and thus the spacing between the NFC ANT and the N78 ANT is required to be increased to solve the interference problem. In this case, the NFC ANT is required to be routed close to the inner side of the mobile phone at the center of the mobile phone, affecting the user experience of NFC. The N78 ANT is required to be kept away from the NFC ANT. However, due to limited internal routing space in the mobile phone, increasing the spacing between the NFC ANT and the N78 ANT to solve the interference problem is not feasible.

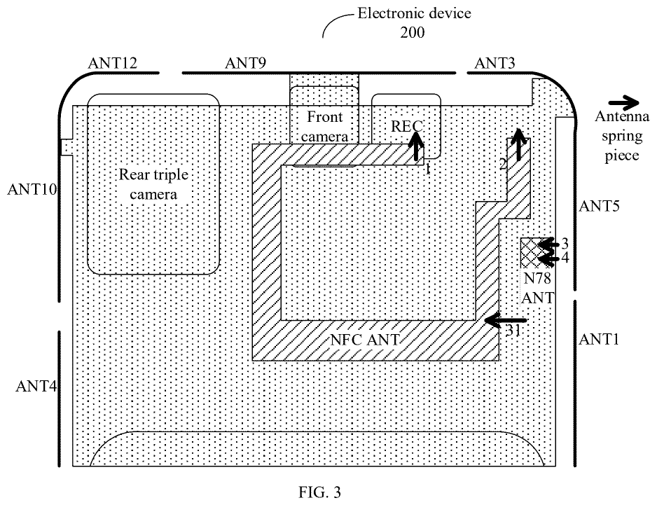

Therefore, to solve the interference problem between the NFC ANT and the N78 ANT, FIG. 3 is a structural schematic view of an example of antennas of an electronic device according to some embodiments of the present disclosure. As shown in FIG. 3, based on FIG. 2, in this example, an antenna spring piece 31 is added on the NFC ANT. The antenna spring piece 31 is connected to the ground of the mainboard via a design of the matching circuit. In this way, by changing the current distribution on the NFC ANT, the impact on the N78 ANT is reduced.

It should be noted that, in FIG. 3, the antenna spring piece 31 is added and connected to the ground of the mainboard via a design of the matching circuit. Thus, even if the NFC ANT and the N78 ANT are disposed close to each other, the interference between the NFC ANT and the N78 ANT may be reduced.

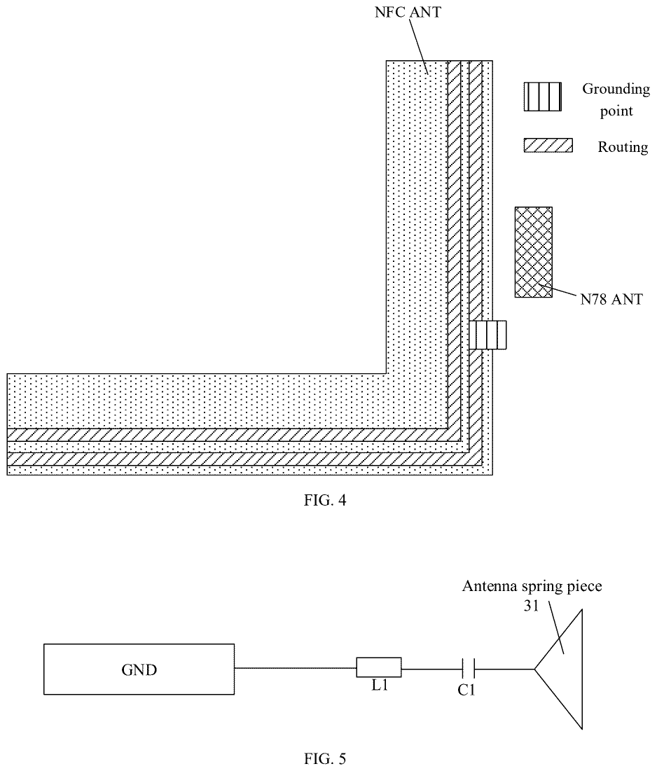

FIG. 4 is a structural schematic diagram of a first example of an antenna routing of an electronic device according to some embodiments of the present disclosure. FIG. 4 shows the routing at the lower right part of the NFC ANT in FIG. 3. A ground point is added at a periphery of the NFC ANT which corresponds to a location of the antenna spring piece 31 in FIG. 3.

FIG. 5 is a structural schematic diagram of a example of an anti-interference circuit according to some embodiments of the present disclosure. As shown in FIG. 5, a matching circuit is configured to be grounded at the newly added ground point in FIG. 4. The matching circuit may include a capacitor C1 and an inductor L1. One end of the capacitor C1 is connected to the newly added ground point in FIG. 4 via the antenna spring piece 31, another end of the capacitor C1 is connected to one end of the inductor L1, and another end of the inductor L1 is connected to ground (GND). The capacitor C1 may be 100 pF and is adjustable in practice. When the NFC ANT operates, the operating frequency is 13.56 MHz, the capacitor C1 is disconnected to reduce the impact of grounding the NFC ANT on the NFC ANT. Additionally, the inductor L1 is an adjustable inductor and configured to change the modal of the high-frequency current of the N78 ANT, thereby changing the flow direction of the current coupled to the NFC ANT from the N78 ANT and extending the electrical length of the grounded current, and thus reducing the interference between the NFC ANT and the N78 ANT.

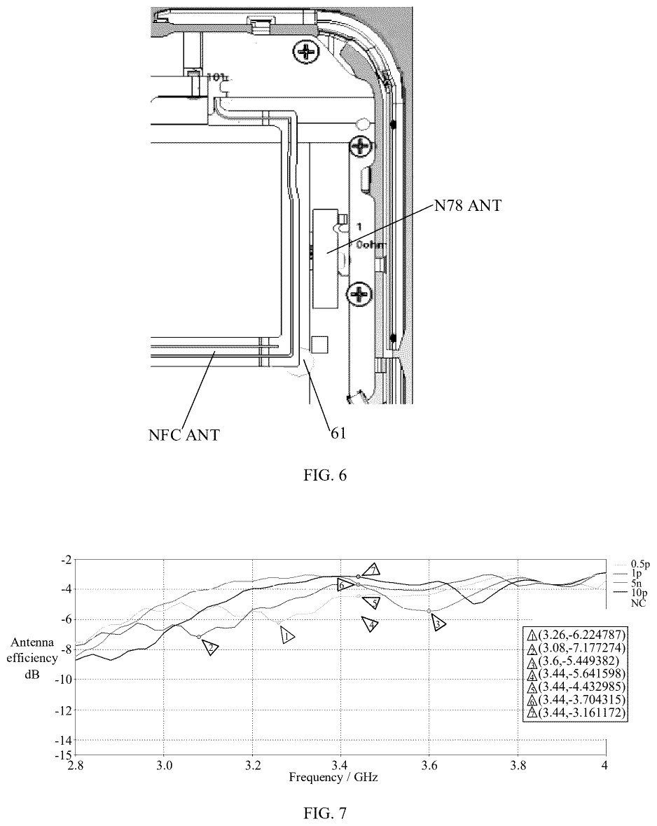

FIG. 6 is a structural schematic view of a second example of an antenna routing of an electronic device according to some embodiments of the present disclosure. FIG. 6 shows the antenna routing at the right side part of the NFC ANT in FIG. 4. Location 61 is the ground point connected to the antenna spring piece 31 in FIG. 3. Based on FIG. 6, the N78 ANT is simulated using an antenna simulation software, and the simulation results are shown in FIG. 7.

FIG. 7 is a schematic diagram of simulation results of antennas according to some embodiments of the present disclosure. FIG. 7 shows the simulation results of the N78 ANT with different capacitance values selected for capacitor C1 in FIG. 5. The simulation results are curves with frequency as the horizontal coordinate and antenna efficiency as the vertical coordinate. For these curves, the curve labeled NC represents the frequency-antenna efficiency curve of the N78 ANT in a case where the NFC ANT is not is connected to the grounded matching circuit. The curve labeled 10p represents the frequency-antenna efficiency curve of the N78 ANT when the capacitor C1 is selected with 10 PF. The curve labeled 5n represents the frequency-antenna efficiency curve of the N78 ANT when the capacitor C1 is selected with 5 NF. The curve labeled Ip represents the frequency-antenna efficiency curve of the N78 ANT when the capacitor C1 is selected with 1 PF. The curve labeled 0.5p represents the frequency-antenna efficiency curve of the N78 ANT when the capacitor C1 is selected with 0.5 PF. Comparing points at labels 5, 6, and 7 with point at label 4 in FIG. 7, it can be seen that when the NFC ANT is connected to the grounded matching circuit, the antenna efficiency at the operating frequency of 3.44 GHz for the N78 ANT improves by 1.5-2.5 dB.

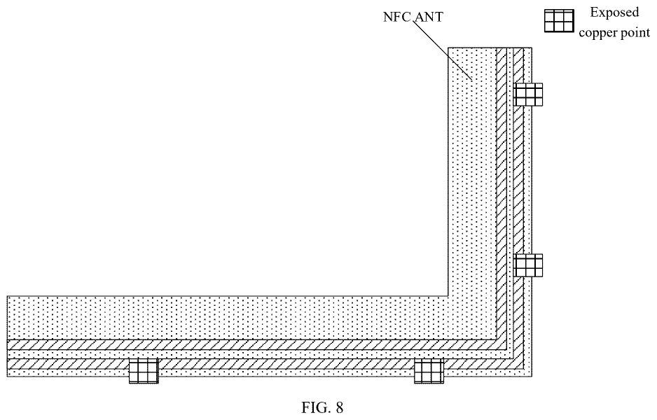

Besides the scheme of adopting the grounded matching circuit to reduce interference between the NFC ANT and the N78 ANT, FIG. 8 is a structural schematic diagram of a third example of antenna routings of an electronic device according to some embodiments of the present disclosure. As shown in FIG. 8, multiple exposed copper points are disposed on the NFC ANT, a grounded foam or other electrical connection forms (e.g., a grounded screw hole) may be configured to achieve grounding. In this case, the exposed copper points are required to be located as close as possible to the physical center point of the NFC ANT. The physical center point is a location on the NFC ANT, other than the ground point, where a voltage is zero. The reason for this configuration is that the voltage at the physical center point of the NFC ANT is 0 V, so that grounding at this location has little impact on the NFC ANT performance.

That is, during the design of NFC ANT, the exposed copper points are reserved. Based on the actual performance debugging situation of N78 ANT, the foam is selected as the grounding point. This grounding point may be as close as possible to the physical center position of the NFC ANT to reduce the impact on the NFC ANT.

It should be noted that the cellular antenna may be an N78 ANT or an antenna with other frequency bands, or may be a Wireless Fidelity (Wi-Fi) antenna, a Bluetooth (BT) antenna, or a Global Positioning System (GPS) antenna, which is not limited.

In this example, through the design of antennas and the matching circuit, the performance of the N78 ANT is improved when the N78 ANT and NFC ANT are coexisted. Moreover, through the design of adding the antenna spring piece and the matching circuit on the NFC ANT, the high-frequency current modal on the NFC ANT is changed, thereby improving the antenna performance of the N78 ANT without reducing the performance of the NFC ANT.

Some embodiments of the present disclosure provide an electronic device, and the electronic device includes a first antenna and a second antenna. The first antenna may be a near field communication antenna disposed above a pressure plate bracket of the electronic device. The first antenna may be disposed adjacent to the second antenna. A radiator of the first antenna is connected to an anti-interference circuit, and a connection point between the first antenna and the anti-interference circuit is located at a location on the radiator of the first antenna other than a feed point and a ground point of the first antenna, and the anti-interference circuit is configured to reduce interference between the first antenna and the second antenna. That is, in some embodiments of the present disclosure, when interference generated between the near field communication antenna on the pressure plate bracket and the adjacent second antenna, by connecting the anti-interference circuit to a location on the radiator of the first antenna other than the feed point and the ground point of the first antenna, the interference generated between the near field communication antenna and the second antenna may be reduced. Thus, without increasing the spacing between the near field communication antenna and the second antenna under the condition of limited internal space in the electronic device, the interference generated between the near field communication antenna and the second antenna may be reduced, thereby improving the antenna efficiencies of the near field communication antenna and the second antenna.

The computer-readable storage medium may be a ferromagnetic random access memory (FRAM), a Read Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disk, or a Compact Disc Read-Only Memory (CD-ROM), etc.

Those skilled in the art should understand that the embodiments of the present disclosure may be provided as methods, systems, or computer program products. Therefore, the present disclosure may take the form of hardware embodiments, software embodiments, or embodiments combining software and hardware aspects. Furthermore, the present disclosure may take the form of a computer program product implemented on one or more computer-usable storage medium (including but not limited to disk storage and optical storage, etc.) including computer-usable program codes.

The present disclosure is described with reference to flowcharts and/or block diagrams of methods, devices (systems), and computer program products according to the embodiments of the present disclosure. It should be understood that each flow and/or block in the flowcharts and/or block diagrams, and combinations of flows and/or blocks in the flowcharts and/or block diagrams, may be implemented by computer program instructions. These computer program instructions may be provided to a processor of a general-purpose computer, special-purpose computer, embedded processor, or other programmable data processing device to produce a machine, such that the instructions, which are executed via the processor of the computer or other programmable data processing device, create an apparatus for implementing the functions specified in one or more flows of the flowchart and/or one or more blocks of the block diagram.

These computer program instructions may also be stored in a computer-readable memory that may direct a computer or other programmable data processing device to operate in a particular manner, such that the instructions stored in the computer-readable memory produce an article of manufacture including an instruction apparatus which implement the function specified in one or more flows of the flowchart and/or one or more blocks of the block diagram.

These computer program instructions may also be loaded onto a computer or other programmable data processing device to cause a series of operational steps to be performed on the computer or other programmable device to produce a computer-implemented process, such that the instructions which execute on the computer or other programmable device provide operations for implementing the functions specified in one or more flows of the flowchart and/or one or more blocks of the block diagram.

The above are only some embodiments of the present disclosure and are not intended to limit the scope of the present disclosure.

1. An electronic device, comprising a first antenna and a second antenna; wherein the first antenna is a near field communication antenna disposed above a pressure plate bracket of the electronic device, and is disposed adjacent to the second antenna;
an anti-interference circuit is connected to a radiator of the first antenna, and a connection point between the radiator and the anti-interference circuit is located at a location other than a feed point of the first antenna and a ground point of the first antenna on the radiator of the first antenna;
the anti-interference circuit is configured to reduce interference between the first antenna and the second antenna.

2. The electronic device as claimed in claim 1, wherein the anti-interference circuit comprises a grounding circuit;
the grounding circuit is connected to the radiator of the first antenna.

3. The electronic device as claimed in claim 2, wherein the grounding circuit is grounded through an antenna spring piece, a foam, an exposed copper, or a screw hole.

4. The electronic device as claimed in claim 2, wherein the anti-interference circuit further comprises a matching circuit;
the matching circuit comprises a capacitor and an inductor; one end of the capacitor is connected to the radiator of the first antenna, another end of the capacitor is connected to one end of the inductor, and another end of the inductor is connected to the grounding circuit.

5. The electronic device as claimed in claim 4, wherein the capacitor is configured to disconnect the radiator of the first antenna to the grounding circuit when the first antenna operates at an operating frequency band of the first antenna.

6. The electronic device as claimed in claim 4, wherein the inductor is configured to change a flow direction of a current coupled to the first antenna from the second antenna and reduce an interference from the second antenna.

7. The electronic device as claimed in claim 2, wherein
the connection point between the first antenna and the anti-interference circuit is located at a location where a voltage is zero on the radiator of the first antenna, other than the feed point of the first antenna and the ground point of the first antenna.

8. The electronic device as claimed in claim 4, wherein a distance between the connection point between the first antenna and the anti-interference circuit and a location at which maximum current exists on the second antenna is inversely correlated with an anti-interference capability of the anti-interference circuit.

9. The electronic device as claimed in claim 8, wherein the connection point between the first antenna and the anti-interference circuit is located on the radiator of the first antenna and is closest to the location at which the maximum current exists on the second antenna.

10. The electronic device as claimed in claim 1, wherein the second antenna is any one of a cellular antenna, a Wireless Fidelity antenna, a Bluetooth antenna, and a Global Positioning System antenna.

11. The electronic device as claimed in claim 1, wherein,
the second antenna is located on the pressure plate bracket of the electronic device or is a part of a frame of the electronic device.

12. The electronic device as claimed in claim 1, wherein the radiator is routed in a shape of U, in a shape of rectangular with an opening, or in an irregular shape.

13. An electronic device, comprising a first antenna and a second antenna disposed adjacent to the first antenna, the first antenna being a near field communication antenna;
wherein a location other than a feed point of the first antenna and a ground point of the first antenna on a radiator of the first antenna is grounded to reduce interference between the first antenna and the second antenna.

14. The electronic device as claimed in claim 13, wherein the location other than the feed point and the ground point of the first antenna on the radiator of the first antenna is grounded through an antenna spring piece.

15. The electronic device as claimed in claim 13, further comprising a matching circuit, one end being connected to the location other than the feed point and the ground point of the first antenna on the radiator of the first antenna through an antenna spring piece, another end being grounded, such that the location other than the feed point and the ground point of the first antenna on the radiator is grounded.

16. The electronic device as claimed in claim 15, wherein the matching circuit comprises a capacitor and an inductor, wherein one end of the capacitor is connected to the location other than the feed point and the ground point of the first antenna on the radiator of the first antenna through the antenna spring piece, another end of the capacitor is connected to one end of the inductor, and another end of the inductor is grounded.

17. The electronic device as claimed in claim 16, wherein the another end of the inductor is grounded through another antenna spring piece.

18. An electronic device, comprising a first antenna and a second antenna disposed adjacent to the first antenna, the first antenna being a near field communication antenna;
wherein a plurality of exposed copper points are disposed on a radiator of the first antenna to reduce interference between the first antenna and the second antenna.

19. The electronic device as claimed in claim 18, wherein the plurality of exposed copper points are disposed close to a physical center point of the radiator of the first antenna, and the physical center point of the radiator of the first antenna has a voltage of zero.

20. The electronic device as claimed in claim 18, wherein each of the plurality of exposed copper points is grounded through a foam.
